(19) United States
(12) Patent Application Publication
(10) Pub. No.: US 2015/0323389 A1
(43) Pub. Date: Nov. 12, 2015

(54) FLOATING ILLUMINATION THERMOMETER

(71) Applicant: Clear Innovation LLC, New York, NY (US)

(72) Inventor: Maurice S. Dayan, Oakhurst, NJ (US)

(21) Appl. No.: 14/270,621

(22) Filed: May 6, 2014

(51) Int. Cl. G01K 1/14; G01K 13/00; G01K 1/02

(52) U.S. Cl. CPC G01K 1/14; G01K 1/02; G01K 13/00

(57) ABSTRACT

A floating illumination thermometer apparatus. In one embodiment, the invention can be a floating illumination thermometer apparatus including: a first light-transmissive housing; a thermometer device coupled to and extending downward from the first light transmissive housing; and a circuit comprising, in operable coupling, a power source, an illumination assembly, and a switch; the illumination assembly configured to generate: (1) a first light into the first light-transmissive housing to illuminate at least a portion of the first light-transmissive housing; and (2) a second light onto the thermometer device to illuminate at least a portion of the thermometer device.

### BACKGROUND

Thermometers have been placed in bodies of water such as pools, aquariums, and ponds to provide a measure of the water's temperature. These thermometers can be designed such that a portion of the thermometer floats in the water. But conventional water thermometers suffer from various drawbacks, including a lack of decorative appearance and a satisfactory means of illuminating both the thermometer gauge and the thermometer's decorative elements.

### BRIEF SUMMARY

The present invention is directed to a floating illumination thermometer apparatus having a floatable housing, a thermometer device for measuring the temperature of surrounding water, and an illumination assembly.

In one embodiment, the invention can be a floating illumination thermometer apparatus comprising: a first light-transmissive housing; a thermometer device coupled to and extending downward from the first light transmissive housing; and a circuit comprising, in operable coupling, a power source, an illumination assembly, and a switch; the illumination assembly configured to generate: (1) a first light into the first light-transmissive housing to illuminate at least a portion of the first light-transmissive housing; and (2) a second light onto the thermometer device to illuminate at least a portion of the thermometer device.

In another embodiment, the invention can be a floating illumination thermometer apparatus comprising: a first light-transmissive housing comprising a first sealed chamber; a second light-transmissive housing disposed within the first sealed chamber, the second light-transmissive housing comprising a second sealed chamber; a circuit disposed within the second sealed chamber, the circuit comprising, in operable coupling, a power source, a board, a first illumination source positioned on an upper surface of the board, a second illumination source positioned on a lower surface of the board, and a switch; a third light-transmissive housing extending from a bottom of the second light transmissive housing, the third light-transmissive housing comprising a third chamber and one or more apertures for allowing water to enter the third chamber; and a thermometer device disposed in the third chamber; the first illumination source configured to generate a first light into the first sealed chamber to illuminate at least a portion of the first light-transmissive housing; and the second illumination source configured to generate a second light into the third chamber to illuminate a gauge surface of the thermometer device.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a floating illumination thermometer in accordance with an embodiment of the present invention.

FIG. 2 is a side view of the floating illumination thermometer of FIG. 1.

FIG. 3 is a cross sectional view taken along line IV-IV of FIG. 1.

FIG. 4 is a cross sectional view taken along line III-III of FIG. 1.

FIG. 5 is a cross section view of the floating illumination thermometer in accordance with an alternative embodiment of the present invention.

### DETAILED DESCRIPTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of the exemplary embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “left,” “right,” “top,” “bottom,” “front” and “rear” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” “secured” and similar refer to a relationship wherein structures are secured or attached to one another either directly or indirectly through intervening structures, as well as both movable or rigid attachments or relationships, unless expressly described otherwise. Moreover, the features and benefits of the invention are described by reference to the exemplary embodiments illustrated herein. Accordingly, the invention expressly should not be limited to such exemplary embodiments, even if indicated as being preferred. The discussion herein describes and illustrates some possible non-limiting combinations of features that may exist alone or in other combinations of features. The scope of the invention is defined by the claims appended hereto.

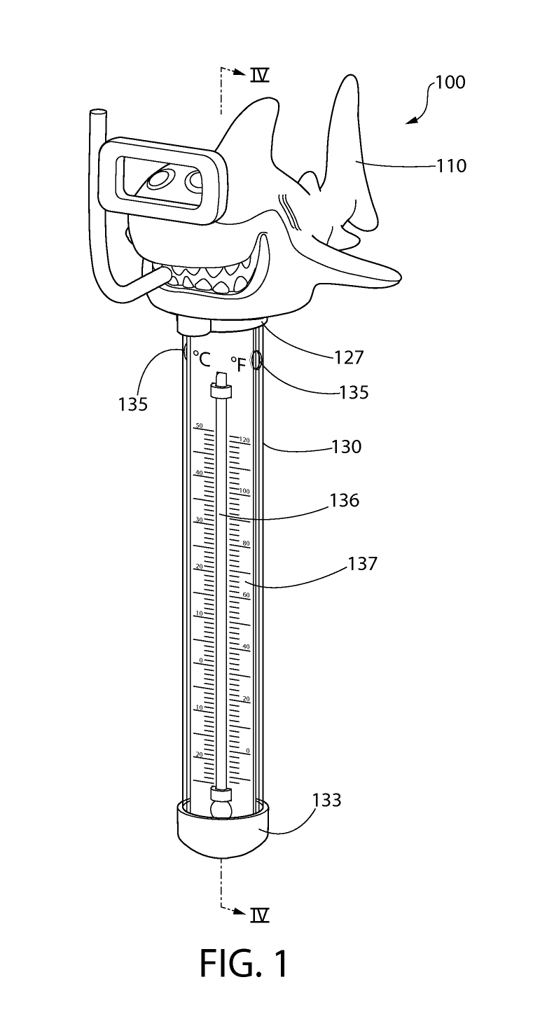

FIG. 1 shows a floating illumination thermometer 100 in accordance with an embodiment of the present invention. In this embodiment, the floating illumination thermometer 100 comprises a first light-transmissive housing 110 that is contoured in the shape of a three-dimensional shark. The invention is not to be so limited, as the first light-transmissive housing 110 can take on any shape to create a desired aesthetic effect. For example, the first housing 110 could be in the shape of another animal or a character, such as a cartoon character. The first housing 110 can include different colors to enhance the decorative effect.

In certain embodiments, the first light-transmissive housing 110 is made of a translucent material. The first housing 110 can take on any color in the color spectrum so long as it has translucent qualities such that light can pass through the first housing 110 to achieve a desired aesthetic effect. The thickness of the material that forms the first housing 110 affects the light transmissivity of the first housing 110, and it is merely desirable that all characteristics of the housing 110 including color and thickness facilitate the illumination of light through the housing 110. In other embodiments, the first housing 110 is made of a transparent or substantially transparent material.

In the exemplified embodiment, the first light-transmissive housing 110 comprises a substantially soft, flexible material, such as a thermoplastic, including but not limited to high-density polyethylene, polyvinyl chloride, or thermoplastic elastomer. Such a soft plastic material can bend or move, but will bias back to its original shape. An advantage of using a soft plastic is that if someone in the same body of water accidentally hits into the first housing 110, the soft plastic will help absorb the contact and reduce the risk of injury.

As will be explained in further detail below, in certain embodiments the first housing 110 is sealed to create a first sealed chamber 112. The first sealed chamber 112 is configured to render the first housing 110 substantially hollow. The first housing 110 can then contain an amount of gas sufficient to render the first light-transmissive housing 110 sufficiently buoyant that the floating illumination thermometer apparatus 100 floats in a body of water. This gas can be air or any other gas of sufficient density to enable the floating illumination thermometer apparatus 100 to float in a body of water. In other embodiments, the first light-transmissive housing 110 is solid, but for a cavity for receiving a second light transmissive housing 120. Rather than being filled by a gas, the first housing 110 is comprised of a buoyant material capable of enabling the floating illumination thermometer 100 to float. The buoyant material can be Styrofoam, cork, certain types of wood, or any other material of a density sufficient to float in water.

FIG. 1 further illustrates a thermometer device 136 extending downward from the first light-transmissive housing 110 in accordance with an exemplary embodiment. The thermometer device 136 is housed within an unsealed housing 130 (also referred to herein as the third light-transmissive housing 130). The unsealed housing 130 is elongated and tubular in shape and is made of a translucent material such that a user can see through the unsealed housing 130 read the gauge surface 137. The thermometer device 136 is a liquid-in-glass thermometer. In other embodiments, the thermometer device 136 could be another type of thermometer, such as those providing a digital display, and the unsealed housing could take on a variety of shapes.

In the exemplified embodiment, there is an opening at the bottom end 132 of the elongated tubular unsealed housing 130 where a cap 133 is coupled. The cap 133 is made of rubber or a plastic material, though alternative embodiments could make the cap 133 of any suitable material for coupling to the unsealed housing 130. The gauge surface 137 of the thermometer device 136 enables a user to read the temperature of the surrounding water 160. Such gauge surfaces 136 will typically indicate the temperature in both degrees Fahrenheit and Celsius, though the invention does not require both measures. The unsealed housing 130 comprises apertures 135 located at the upper portion of the housing 130 and in the cap 133. As will later be described in more detail, these apertures 135, 134 allow surrounding water 160 to enter the unsealed housing 130 such that the thermometer device 136 is immersed in water 160 and can thereby provide a measure of the temperature of the surrounding water 160.

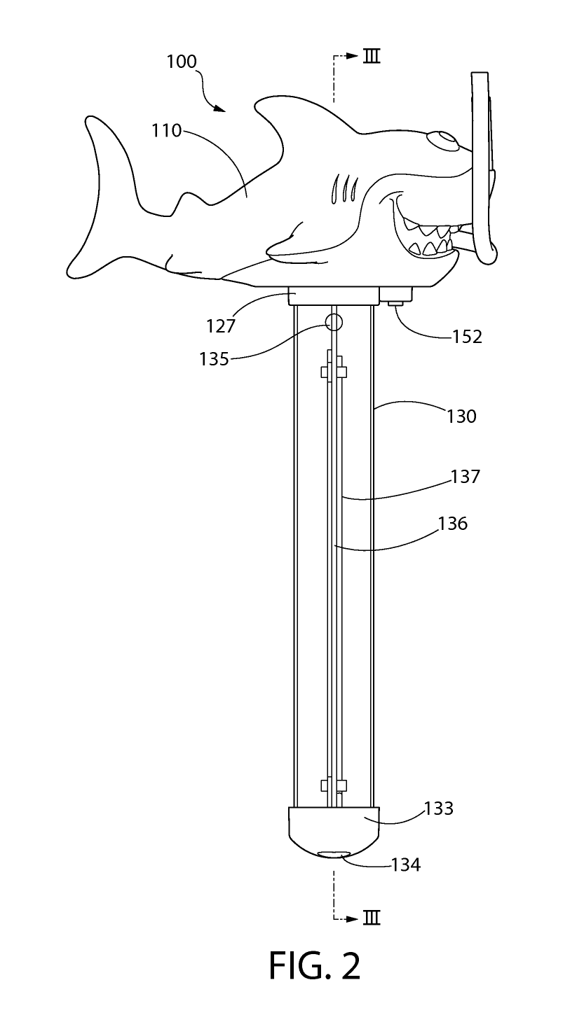

FIG. 2 shows a side view of the exemplified embodiment of FIG. 1. Similar to FIG. 1, this figure shows the thermometer device 136 extending downward from the first light-transmissive housing 100, the unsealed elongated tubular housing 130, the cap 133 coupled to the bottom end 132 of the elongated tubular unsealed housing 130, an aperture 135 in the unsealed housing 130, and an aperture 134 in the cap 133. FIG. 2 further illustrates an annular collar 127 for coupling the first housing 110 to the unsealed housing 130. The annular collar 127 can fit around the unsealed housing 130 and be permanently or non-permanently affixed to the unsealed housing 130 by adhesive, a threading mechanism, or any other coupling means. In alternative embodiments, the annular collar 127 is omitted in favor of an alternative coupling means. For example, the housings could be formed from a single piece of plastic. FIG. 2 also shows the switch 152 for turning on or off the illumination assembly 154. When the switch 152 of the floating illumination thermometer 100 is turned on, the first housing 110 is illuminated to create a decorative effect and the unsealed housing 130 is illuminated to assist a user in reading the gauge surface 137.

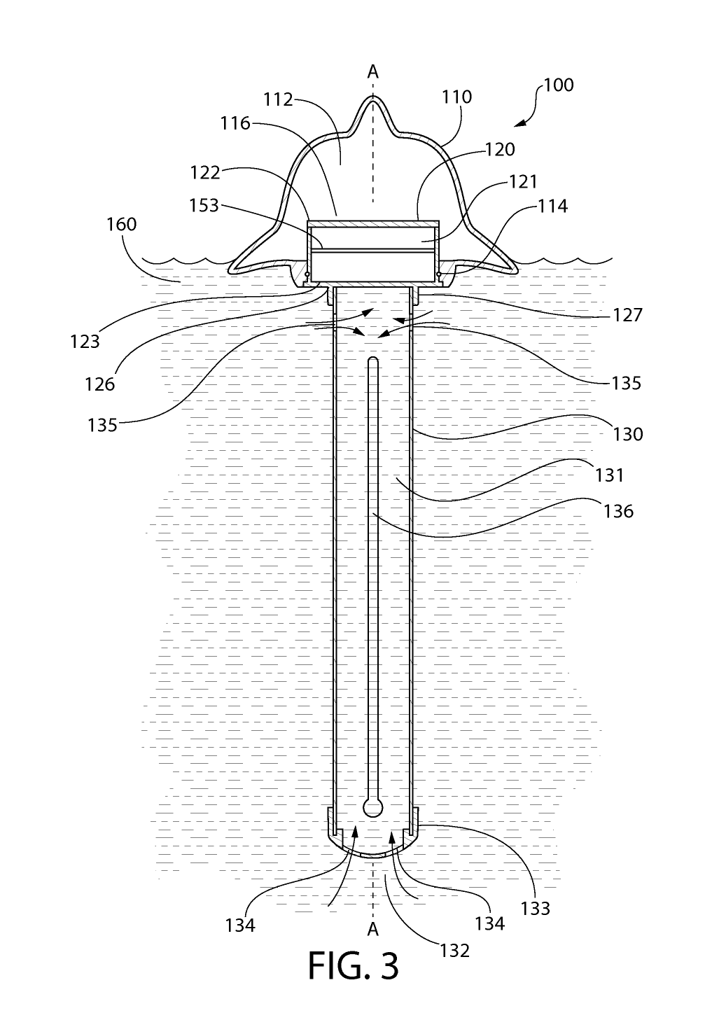

FIG. 3 shows a cross sectional view of the floating illumination thermometer 100 taken along line IV-IV of FIG. 1, wherein the floating illumination thermometer apparatus 100 is floating in water 160. In the exemplified embodiment, the first light-transmissive housing 110 comprises an opening 116 in a bottom portion 116 thereof. A second light-transmissive housing 120 is positioned within this opening 116 and helps seal the opening 116. A gasket 114 is positioned between the first light-transmissive housing 110 and the second light-transmissive housing 120 to ensure that opening 116 is sealed. The gasket 114 circumferentially surrounds the second housing 120. The gasket 114 is formed of a resilient material such as rubber and provides a watertight seal between the first housing 110 and the second housing 120 when the housings 110, 120 are coupled together. More specifically, the gasket 114 facilitates preventing water 160 and other liquids or debris from entering in the first sealed chamber 112 of the first housing 110 by being compressed between the first housing 110 and the second housing 120 when the housings 110, 120 are coupled together. In alternative embodiments, a gasket 114 is not used and instead the first housing 110 and second housing 120 are shaped sufficient to provide a watertight seal and thereby prevent water 160 from entering the first sealed chamber 112.

In the exemplified embodiment, the first light-transmissive housing 110 comprises a first sealed chamber 112 and the second light-transmissive housing 120 is disposed within the first sealed chamber 112, the second light-transmissive housing 120 comprising a second sealed chamber 121. The first sealed chamber 110 and the second sealed chamber 120 can be considered separate, or it can be considered that the first and second light-transmissive housings 110, 120 collectively form the first sealed chamber 112 such that the second sealed chamber 121 forms part of the first sealed chamber. In alternative embodiments, a single housing containing a single, undivided chamber connects directly to the unsealed housing 130.

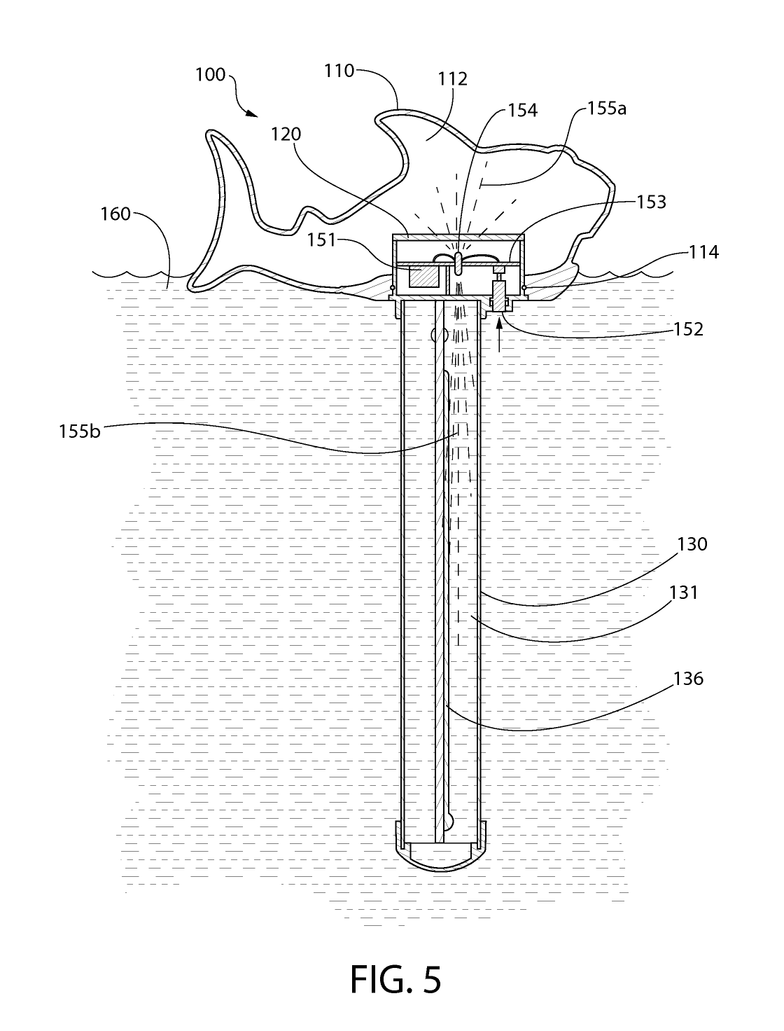

In the exemplified embodiment, the second light-transmissive housing 120 comprises a top plate 122 and a bottom plate 123 that are substantially parallel. A board 153 is disposed within the second sealed chamber 121 between the top plate 122 and bottom plate 123. The board 153 is substantially parallel to the top plate 122 and bottom plate 123. A circuit 150 and an illumination assembly 154 can be disposed upon the board 153. These features are discussed in greater detail in reference to FIG. 5.

FIG. 3 shows the thermometer device 136 extending along a longitudinal axis A that is substantially perpendicular to the upper and lower surfaces of the board 153. The second light-transmissive housing 120 comprises the annular collar 127, which extends from a lower surface 126 of the second light-transmissive housing 120. The third-light transmissive housing 130 is coupled to the second light-transmissive housing 120 via the annular collar 127. As discussed above, in alternative embodiments, the first housing 110 and second housing 120 could be a single housing (comprising a single chamber) coupled to the unsealed housing 130 of the thermometer device 136. This coupling could be accomplished via an annular collar or any other coupling means, including forming the housings from a single piece of plastic.

In the exemplified embodiment, the third light-transmissive housing 130 comprises a third chamber 131 in which the thermometer device 136 is disposed. The third light-transmissive housing 130 further comprises apertures 134, 135 for allowing water 160 to enter the third chamber 131. Specifically, the cap 133, which is coupled to the bottom end 132 of the third housing 130, comprises two first apertures 134. Arrows in FIG. 3 indicate surrounding water 160 flowing into the third chamber 131 through these first apertures 134. Further, the unsealed housing 130 comprises second apertures 135 located at the upper portion of the housing 130. Arrows in FIG. 3 indicate surrounding water 160 flowing into the third chamber 131 through these second apertures 135. As a result of surrounding water 160 entering the third chamber 131, the thermometer device 136 is immersed in water such that the thermometer device 136 can provide a measure of the temperature of the surrounding water 160. In alternative embodiments, the apertures 134, 135 are positioned at different locations that are nevertheless sufficient to enable water 160 to enter the unsealed housing 130. Further, the cap 133 can be removed in favor of allowing water 160 through an opening at the bottom end of the third housing 130 or through other apertures or openings.

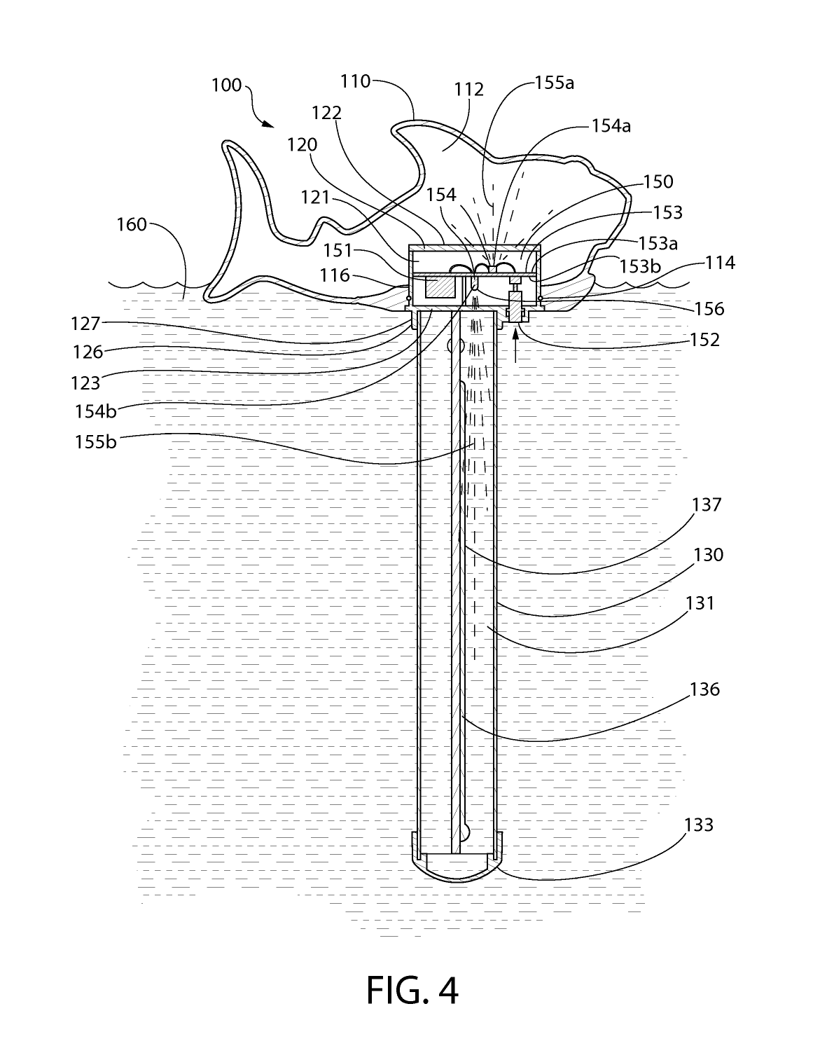

FIG. 4 is a cross sectional view taken along line III-III of FIG. 1, wherein the floating illumination thermometer 100 is floating in water 160. In this exemplified embodiment of the illumination assembly 154, the second light-transmissive housing 120 comprises a top plate 122 and a bottom plate 123 that are substantially parallel. The board 153 is disposed within the second sealed chamber 121 between the top plate 122 and bottom plate 123. The board 153 is substantially parallel to the top plate 122 and bottom plate 123. A circuit 150 disposed within the second sealed chamber 121 comprises, in operable coupling, a power source 151, a board 153, an illumination assembly 154, and a switch 152. In this embodiment, the illumination assembly 154 comprises a first illumination source 154a positioned on an upper surface 153a of the board 153, and a second illumination source 154b positioned on a lower surface 153b of the board 153. The first illumination source 154a is configured to generate a first light 155a into the first light-transmissive housing 110 (and/or the first sealed chamber 112) to illuminate at least a portion of the first light-transmissive housing 110, and the second illumination source 154b is configured to generate a second light 155b into the third chamber 131 to illuminate a gauge surface 137 of the thermometer device 136. In this embodiment, the first illumination source 154a and second illumination source 154b are axially offset from one another to maximize lighting of the first housing 110 and gauge surface 137. Further, the second illumination source 154b comprises a lens 156 configured to focus a portion of the second light 155b on the gauge surface 137. The lens 156 can be made of plastic or any other suitable material for focusing the second light 155b. In this embodiment, the first illumination source 154a generates the first light 155a so as to have a first angle of incidence relative to the upper surface 153a of the board 153 and the second illumination source 154b generates the second light 155b so as to have a second angle of incidence relative to the lower surface 153b of the board 153, the first angle of incidence being greater than the second angle of incidence. In other embodiments, the second housing 120 can take a variety of shapes for accommodating the circuit 150. Further, the illumination sources 154a, 154b can be axially aligned, the lens 156 for focusing the second light 155b can be omitted, and the lights 155a, 155b can have similar angles of incidence. Further, if the first housing 110 is solid such that there is no first sealed chamber 112 to receive the first light 155a, the first light 155a can directly illuminate the first housing 110.

The illumination assembly 154 can be turned on and off by the switch 152, which can be accessed by a user at the lower surface 126 of the second light-transmissive housing 120. In alternative embodiments, the switch 152 can be positioned at other locations on the floating illumination thermometer 100, such as directly on the first housing 110. In certain embodiments, the switch 152 is activated by a push button as shown by the arrow in FIG. 4. In other embodiments, the switch can be a slide-actuated switch or another type of switch.

In certain embodiments, the power source 151 comprises a plurality of batteries. In other embodiments, the power source 151 can be a single battery, a solar power unit, or any other type of power source. The circuit 150 can comprise electrical contacts and other commonly known electrical components necessary to enable the light assembly to function as described.

FIG. 5 is a cross section view of the floating illumination thermometer 100 in accordance with an alternative embodiment of the present invention. This embodiment is similar to the embodiment shown in FIG. 4, but the illumination assembly 154 comprises a single illumination source configured to generate the first light 155a and the second light 155b. In this embodiment, the board 153 comprises an opening, and the single light source 154 is disposed within the opening. In an alternative embodiment, the single light source 154 can be disposed in alignment with the opening, such that the light source 154 can shine light through the opening such that light is present on both the sides of the board 153. Alternatively, the single light source 154 can be positioned adjacent to a distal edge of the board 153 to enable light to be present on either side of the board 153.

In the exemplary embodiment, the illumination sources 154, 154a, 154b are light emitting diodes (“LEDs”). In alternative embodiments, the illumination sources 154, 154a, 154b are light bulbs or any other device capable of producing light. Further, the illumination sources 154, 154a, 154b can be selected to produce light in any color desired.

In the exemplary embodiment, the third light transmissive housing 130 comprises a substantially rigid plastic material. More specifically, the material that forms the third housing 130 is more rigid than the material that forms the first housing 110. In other embodiments, the first housing 110 and third housing 130 can be formed of the same material, or of different materials having similar rigidity. In the exemplified embodiment, the third housing 130 and the second housing 120 are formed of substantially transparent material. The third housing 130 uses transparent material or clear material to help the user read the gauge surface 137, and the second housing 120 uses transparent material to ensure that adequate light reaches the first housing 110. In alternative embodiments, translucent or other light permeable materials can be used for the second housing 120 and third housing 130.

What is claimed is:

1. A floating illumination thermometer apparatus comprising:
a first light-transmissive housing comprising a first sealed chamber;
a second light-transmissive housing disposed within the first sealed chamber, the second light-transmissive housing comprising a second sealed chamber;
a circuit disposed within the second sealed chamber, the circuit comprising, in operable coupling, a power source, a board, a first illumination source positioned on an upper surface of the board, a second illumination source positioned on a lower surface of the board, and a switch;
a third light-transmissive housing extending from a bottom of the second light transmissive housing, the third light-transmissive housing comprising a third chamber and one or more apertures for allowing water to enter the third chamber; and
a thermometer device disposed in the third chamber;
the first illumination source configured to generate a first light into the first sealed chamber to illuminate at least a portion of the first light-transmissive housing; and
the second illumination source configured to generate a second light into the third chamber to illuminate a gauge surface of the thermometer device.

2. The floating illumination thermometer apparatus of claim 1, wherein the switch is accessible from a lower surface of the second light-transmissive housing.

3. The floating illumination thermometer apparatus of claim 1, wherein the second light-transmissive housing comprises an annular collar extending from a lower surface of the second light-transmissive housing, the third light transmissive housing coupled to the second light-transmissive housing via the annular collar.

4. The floating illumination thermometer apparatus of claim 1, wherein the second light-transmissive housing comprises a top plate and a bottom plate that are substantially parallel, the board disposed between the plates and substantially parallel to the top and bottom plates.

5. The floating illumination thermometer apparatus of claim 1, wherein the first light-transmissive housing is configured to contain an amount of gas sufficient to render the first light-transmissive housing sufficiently buoyant that the floating illumination thermometer apparatus floats in a body of water.

6. The floating illumination thermometer apparatus of claim 1, wherein the second illumination source comprises a lens configured to focus a portion of the second light on the gauge surface.

7. The floating illumination thermometer apparatus of claim 1, wherein the thermometer device extends along a longitudinal axis that is substantially perpendicular to the upper and lower surfaces of the board.

8. The floating illumination thermometer apparatus of claim 1, wherein the first and second light-transmissive housings collectively form the first sealed chamber.

9. The floating illumination thermometer apparatus of claim 8 further comprising a gasket positioned between the first and second light-transmissive housings.

10. The floating illumination thermometer apparatus of claim 1, wherein the first light-transmissive housing is three-dimensionally contoured in the form of an animal or character.

11. The floating illumination thermometer apparatus of claim 1, wherein the first light-transmissive housing comprises a substantially soft plastic and the third light-transmissive housing comprises a substantially rigid plastic.

12. The floating illumination thermometer apparatus of claim 1, wherein the first light-transmissive housing comprises an opening in a bottom portion thereof, the second light-transmissive housing positioned within and sealing the opening.

13. The floating illumination thermometer apparatus of claim 1, wherein the first light-transmissive housing is translucent and the second and third light-transmissive housings are substantially transparent.

14. The floating illumination thermometer apparatus of claim 1, wherein the third light-transmissive housing is an elongated tubular housing and comprises a cap coupled to a bottom end of the elongated tubular housing.

15. The floating illumination thermometer apparatus of claim 14, wherein the cap comprises a first aperture for allowing water to enter the third chamber, and an upper portion of the elongated tubular housing comprises a second aperture for allowing water to enter the third chamber.

16. The floating illumination thermometer apparatus of claim 1, wherein the first and second illumination sources are axially offset from one another.

17. The floating illumination thermometer apparatus of claim 1, wherein the first illumination source generates the first light so as to have a first angle of incidence relative to the upper surface of the board and the second illumination source generates the second light so as to have a second angle of incidence relative to the lower surface of the board, the first angle of incidence being greater than the second angle of incidence.

18. A floating illumination thermometer apparatus comprising:
a first light-transmissive housing;
a thermometer device coupled to and extending downward from the first light transmissive housing; and
a circuit comprising, in operable coupling, a power source, an illumination assembly, and a switch;
the illumination assembly configured to generate: (1) a first light into the first light-transmissive housing to illuminate at least a portion of the first light-transmissive housing; and (2) a second light onto the thermometer device to illuminate at least a portion of the thermometer device.

19. The floating illumination thermometer apparatus of claim 18, wherein the illumination assembly comprises a first illumination source and a second illumination source, the first illumination source configured to generate the first light and the second illumination source configured to generate the second light.

20. The floating illumination thermometer apparatus of claim 18, wherein a second light-transmissive housing is disposed within the first light-transmissive housing, the second light transmissive housing comprising a sealed chamber.

21. The floating illumination thermometer apparatus of claim 20, wherein the circuit is disposed within the sealed chamber, the circuit further comprising a board, a first illumination source positioned on an upper surface of the board and configured to generate the first light, and a second illumination source positioned on a lower surface of the board and configured to generate the second light.

22. The floating illumination thermometer apparatus of claim 20, wherein a third light transmissive housing extending from a bottom of the second light transmissive housing, the third light transmissive housing comprising (a) an unsealed chamber in which the thermometer is disposed and (b) one or more apertures for allowing water to enter the sealed chamber.

23. The floating illumination thermometer apparatus of claim 18, wherein the illumination assembly comprises a single illumination source, the single illumination source configured to generate the first light and the second light.

24. The floating illumination thermometer apparatus of claim 23, wherein the circuit comprises a board disposed within the first light-transmissive housing.

25. The floating illumination thermometer apparatus of claim 24, wherein the board comprises an opening, the single light source disposed in alignment with the opening.

26. The floating illumination thermometer apparatus of claim 24, wherein the board comprises an opening, the single light source disposed within the opening.

27. The floating illumination thermometer apparatus of claim 24, wherein the board comprises a distal edge, the single light source disposed adjacent to the distal edge.

28. The floating illumination thermometer apparatus of claim 23, wherein the single illumination source is a light emitting diode.

29. The floating illumination thermometer apparatus of claim 18, wherein the first light-transmissive housing comprises a first housing chamber rendering the first housing substantially hollow.

30. The floating illumination thermometer apparatus of claim 18, wherein the first transmissive housing is solid but for a cavity for receiving the second light-transmissive housing.

31. The floating illumination thermometer apparatus of claim 30, wherein the first light-transmissive housing comprises a buoyant material.

32. A floating illumination thermometer apparatus comprising:
a first light-transmissive housing comprising a first sealed chamber;
a second light-transmissive housing disposed within the first sealed chamber, the second light-transmissive housing comprising a second sealed chamber;
a circuit disposed within the second sealed chamber, the circuit comprising, in operable coupling, a power source, a board, a first illumination source positioned on an upper surface of the board, a second illumination source positioned on a lower surface of the board, and a switch;
a third light-transmissive housing extending from a bottom of the second light transmissive housing, the third light-transmissive housing comprising a third chamber and one or more apertures for allowing water to enter the third chamber;
a thermometer device disposed in the third chamber;
the first illumination source configured to generate a first light into the first sealed chamber to illuminate at least a portion of the first light-transmissive housing; and
the second illumination source configured to generate a second light into the third chamber to illuminate a gauge surface of the thermometer device;
wherein the switch is accessible from a lower surface of the second light-transmissive housing;
wherein the second light-transmissive housing comprises an annular collar extending from a lower surface of the second light-transmissive housing, the third light transmissive housing coupled to the second light-transmissive housing via the annular collar;
wherein the second light-transmissive housing comprises a top plate and a bottom plate that are substantially parallel, the board disposed between the plates and substantially parallel to the top and bottom plates;
wherein the first light-transmissive housing is configured to contain an amount of gas sufficient to render the first light-transmissive housing sufficiently buoyant that the floating illumination thermometer apparatus floats in a body of water;
wherein the second illumination source comprises a lens configured to focus a portion of the second light on the gauge surface;
wherein the thermometer device extends along a longitudinal axis that is substantially perpendicular to the upper and lower surfaces of the board;
wherein a gasket is positioned between the first and second light-transmissive housings;
wherein the first light-transmissive housing is three-dimensionally contoured in the form of an animal or character;
wherein the first light-transmissive housing comprises a substantially soft plastic and the third light-transmissive housing comprises a substantially rigid plastic;
wherein the first light-transmissive housing comprises an opening in a bottom portion thereof, the second light-transmissive housing positioned within and sealing the opening;
wherein the first light-transmissive housing is translucent and the second and third light-transmissive housings are substantially transparent;
wherein the third light-transmissive housing is an elongated tubular housing and comprises a cap coupled to a bottom end of the elongated tubular housing;
wherein the cap comprises a first aperture for allowing water to enter the third chamber, and an upper portion of the elongated tubular housing comprises a second aperture for allowing water to enter the third chamber;
wherein the first and second illumination sources are axially offset from one another; and
wherein the first illumination source generates the first light so as to have a first angle of incidence relative to the upper surface of the board and the second illumination source generates the second light so as to have a second angle of incidence relative to the lower surface of the board, the first angle of incidence being greater than the second angle of incidence.
